(19) United States
(12) Patent Application Publication
(10) Pub. No.: US 2025/0382235 A1
(43) Pub. Date: Dec. 18, 2025

(54) PROCESS FOR PRODUCTION OF MONOLITH COMPACTED ALUMINA MATERIAL FOR SINGLE CRYSTAL GROWTH

(71) Applicant: AEM TECHNOLOGIES INC., MONTRÉAL (CA)

(72) Inventors: Fariba SAFIZADEH, Kirkland (CA); Ebrahim ALIZADEH, Blainville (CA); Bahman YARI, Blainville (CA); Yedir YADDADEN, Lac-Beauport (CA); Charles TASCHEREAU, Chambly (CA); Sylvain SEYER, Les Cèdres (CA)

(73) Assignee: AEM TECHNOLOGIES INC., MONTRÉAL, QC (CA)

(21) Appl. No.: 18/877,367

(22) PCT Filed: Jun. 16, 2023
(86) PCT No.: PCT/CA2023/050839

§ 371 Date: Dec. 20, 2024

Related U.S. Application Data
(60) Provisional application No. 63/353,834, filed on Jun. 20, 2022.

(51) Int. Cl. C04B 35/626; C04B 35/111; C04B 35/64

(52) U.S. Cl. CPC C04B 35/6263; C04B 35/111; C04B 35/64; C04B 2235/3217; C04B 2235/5436; C04B 2235/606; C04B 2235/608; C04B 2235/6567; C04B 2235/77

(57) ABSTRACT

The present application relates to the production of a compacted alumina green body and monolith. More specifically, the present application relates to processes for the production of a compacted alumina green body, comprising: pouring a slurry in a casting mold, the slurry comprising micron-sized particles of high-purity alumina and a solvent; and drying the slurry. More specifically, the present application relates to improved process free of a mechanical compaction step providing high density monolith for use in single crystal growth industry.

### CROSS-REFERENCE TO RELATED APPLICATIONS

The present application claims priority to U.S. Application No. 63/353,834 that was filed on Jun. 20, 2022. This document is hereby incorporated by reference in its entirety.

### FIELD

The present application is in the field of the production of alumina. More specifically, the present application relates to processes for the production of compacted alumina material.

### BACKGROUND

Aluminum oxide (Al₂O₃) is one of the most used ceramic materials in the advanced ceramic industry. Alumina is extracted from the bauxite using Bayer process. This material is suitable for numerous applications in various industrial, technical, and military uses due to its high thermal, electrical and physical properties. Nowadays, alumina is employed in several modern industries such as synthetic sapphire, light emitting diode (LED), semiconductor and lithium-ion batteries (LIB), automobile and space craft industry, wear protection, dental and orthopaedic implants.

One specific application is the single crystal growth industry for example synthetic sapphire. For sapphire production, high purity alumina (HPA) is required, which is mostly obtained by calcination of aluminum salts. Such aluminum salt can be, but not limited to, aluminum chloride, aluminum nitrate, aluminum sulfate, ammonium aluminum sulfate and ammonium aluminum carbonate hydroxide, or a hydrate thereof; an organic aluminum salt such as aluminum oxalate, aluminum acetate, aluminum stearate, aluminum lactate and aluminum laurate.

The main drawback of alumina from an aluminum salt for sapphire industry is its low bulk density, which reduces the efficiency and capacity of the sapphire furnaces. For example, the alumina from aluminum chloride hexahydrate has loose bulk density about 0.4 gr/cm³, which is 10 times less than true density of alumina (3.96 gr/cm³). The cycle time of sapphire production is around 3 weeks, which includes heating to melting temperature of alumina (>2000° C.), and then controlled cooling under vacuum. Therefore, if a low-density feed is used in such a furnace (for example alumina from aluminum chloride), only 10% of capacity of the furnace is used. In addition, small density is a sign of porosity that can adsorb considerable amount of gases (for example oxygen, water vapor), which are responsible for bubbles and other defects in the crystal and also significantly reduce the lifetime of the crucible, heating elements and other components of the crystal growth furnaces.

HPA powders must therefore be pre-processed in a way that significantly increase their density and reduces the amount of trapped gases. In order to have a higher efficiency in the sapphire furnace, normally the feed alumina is compacted and sintered prior to feeding to the sapphire furnace. Compaction produces green bodies with an acceptable strength and sintering increases the density of the green bodies. Generally, for single crystal growth, a compacted material with density of higher than 3.2 gr/cm³ is required. Some of the main methods of compacting/forming of ceramic powders are freeze casting, slip casting, powder injection molding, cold isostatic pressing, uniaxial die pressing, extrusion additive manufacturing.

The flowchart presented in FIG. 1 illustrates the process typically used to produce compacted material for sapphire industry. Commercially, these compacted materials are called “puck”. Generally, the feed HPA powder has large granulometry, and compacting/sintering such big granules are not feasible. Therefore, the HPA particles should pass through a grinding step. The typical grinding technique is a wet grinding, where the powder is milled using ceramic grinding media. The product of wet grinder is a slurry of alumina, which should be dried. A typical equipment for drying of alumina slurry is spray dryer. In most of the cases, an organic binder is added to the slurry to enhance the mechanical strength of the green body after compaction step. The binder is used because α-alumina does not easily coalesce. Many sapphire producers experienced problems with compacted material realized with a binder. Such organic binder is normally burnt during sintering process, but it is possible that binder becomes trapped in closed pores, which adds to the impurity level of the material. Small amount of impurities (in the order of ppm) can impact the quality of the obtained single crystal and results in an opaque crystal. An increasing number of suppliers are therefore developing water-based slurries for the sintering processes. Overall, very few suppliers are capable of offering high density (>3.2 gr/cm³, binder free material with high purity).

Operation of a spray dryer present challenges, and it is difficult to dry powder without formation of agglomerates. Formation of agglomerates normally impacts the quality of the compaction step. The compaction is normally done with a uniaxial press machine under high pressure to form a green body. The required pressure is high (10,000-50,000 psi). There are several drawbacks in using such press machine:
High cost of automated apparatus or low production capacity of a manual apparatus.
HPA has poor flowability, which renders the use of automatic feeding of alumina powder impracticable or unreliable. As a result, manual feeding is used, which impacts the production rate.
The material of die and punch in the press machine can be made of tool steel, and such material can add to the impurity level of the HPA powder, especially considering that alumina is an abrasive material. The other option for die and punch material is ceramics (e.g. carbides), in which case the fine HPA powder can flow into the gap between die and punch and can damage the parts.
Alumina powder tend to stick to the punch or die in the alumina compaction process. To solve this issue, a lubricant can be used on the surface of die and punch, but again adding to the impurity of the powder.
As high pressure is required to compact the HPA powder into a green body, production of bigger pucks require higher force, and most die cannot withstand very high load and fracture of the die may result. This mostly happens with rectangular die, where there is high stress in the corners of the mold. To reduce the stress, a cylindrical mold can be used, but this is not preferred since it reduce the capacity of the sapphire furnace to π/4.
The produced compacted material has limited shape and limited dimensions. Then, compacted material should be strategically placed inside the furnace for single crystal growth for space optimization. In addition, gaps exist between the compacted material when not square or rectangular when placed inside the furnace, which reduces the efficiency/capacity of the furnace.

In KR20130022616A, it has been suggested to produce larger compacted material, but the technique still uses a pressing step which increases the chance of cross contamination, and involves higher capital and operating costs as explained above. Moreover, pressing the alumina particle pushes the particles in a random orientation, which retains gaps between the particles. As a result, the obtained green body density provided by such process is 1.9-2.4 gr/cm³. Further, there is a maximum amount of water that can be used in this process. As such, the ground material needs to be spray dried in order to prepare a slurry, thus still involving the spray drying step.

As such, there is need to provide improved processes for the preparation of compacted alumina to overcome at least some of the drawbacks of existing processes.

### SUMMARY

It has been surprisingly shown herein that compacted alumina monolith may be produced according to process of the application, providing larger monoliths having higher density suitable for use in single crystal growth industry such as synthetic sapphire. As such, the process of the present application provides for the production of compacted monolith with reduced level of impurities, while also reducing operations challenges and costs. The present application further provides for the use of these process for the production of compacted alumina monolith, and monoliths obtained therefrom. Comparable processes did not display the same properties, highlighting the surprising results obtained with the process of the application.

Accordingly, the present application includes a process for production of a compacted alumina green body, comprising: pouring a slurry in a casting mold, the slurry comprising micron-sized particles of high-purity alumina and a solvent; and drying the slurry to obtain the compacted alumina green body.

In some embodiments, the high-purity alumina is selected from alpha alumina, transition alumina, amorphous alumina, and a mixture thereof, or the high-purity alumina is doped with at least one element selected from Mg, Ba, Si, Ti, Zr, Fe, W, Zn and rare earth elements, or is a mixture of high-purity alumina and metal oxides.

In some embodiments, the process further comprises grinding the high-purity alumina to obtain the micron-sized particles. In some embodiments, the grinding is conducted in a wet grinder, a dry grinder, a ball mill, an air jet mill or a steam jet mill.

In some embodiments, the micron-sized high-purity alumina particles have a particle size distribution from about 0.5 micron to about 100 microns. In some embodiments, the micron-sized high-purity alumina particles have a particle size distribution from about 0.5 micron to about 50 microns. In some embodiments, the micron-sized high-purity alumina particles have a particle size distribution from about 1 micron to about 5 microns.

In some embodiments, the solvent is in an amount of about 5% to about 75% by weight based on the total weight slurry. In some embodiments, the solvent is in an amount of about 10% to about 40% by weight based on the total weight slurry. In some embodiments, the solvent is in an amount of about 10% to about 20% by weight based on the total weight slurry.

In some embodiments, the slurry is obtained by mixing the high-purity alumina and the solvent. In some embodiments, the solvent is selected from water, methanol, ethanol, isopropanol, acetone and mixtures thereof. In some embodiments, wherein the solvent is water.

In some embodiments, the slurry further comprises an organic binder, a dispersant, or a mixture thereof. In some embodiments, the organic binder is a polymer selected from carboxymethyl-cellulose (CMC), poly-vinyl-alcohols (PVA) and poly-ethylene glycols (PEG). In some embodiments, the dispersant is selected from 4,5-dihydroxy-1,3-benzenedisulfonic acid disodium salt, carbonic acid salt, Ammonium polymethacrylate, Carbonic acid ester, sodium pyrophosphate, diammonium hydrogen citrate, Triammonium salt of aurintricarboxylic acid, Darvan C—N, sodium pyrophosphate, diammonium hydrogen citrate, citric acid, nitric acid, ascorbic acid, ammonium polyacrylate, and polycarbonic acid salt.

In some embodiments, the process further comprises a settlement period before drying the slurry to allow settlement of the micron-sized particles. In some embodiments, the settlement period further comprises vibrating the casting mold. In some embodiments, the settlement period is conducted for about 0.5 hour to about 24 hours. In some embodiments, the settlement period is conducted for about 1 hour to about 12 hours. In some embodiments, the settlement period is conducted for about 1 hour to about 5 hours.

In some embodiments, the drying is conducted in an oven, a gas fired dryer, an electrical dryer or a microwave oven. In some embodiments, the drying is conducted at a temperature of about 15° C. to about 150° C. In some embodiments, the drying comprises heating at a temperature of about 30° C. to about 150° C. In some embodiments, the drying comprises heating at a temperature of about 50° C. to about 150° C.

In some embodiments, the drying is conducted for about 0.5 hour to about 1 week. In some embodiments, the drying is conducted for about 1 hour to about 48 hours. In some embodiments, the drying is conducted for about 12 hours to about 24 hours.

In some embodiments, the process further comprises removing the compacted alumina green body from the casting mold and subjecting the compacted alumina green body to a thermal treatment thereby providing a single unitary compacted alumina piece. In some embodiments, the thermal treatment comprises heating at a temperature of about 150° C. to about 1200° C. In some embodiments, the thermal treatment comprises heating at a temperature of about 200° C. to about 1200° C. In some embodiments, the thermal treatment comprises heating at a temperature of about 250° C. to about 1200° C. In some embodiments, the thermal treatment is conducted for about 0.5 hour to about 24 hours. In some embodiments, the thermal treatment is conducted for about 1 hour to about 12 hours. In some embodiments, the thermal treatment is conducted for about 2 hours to about 5 hours.

In some embodiments, the process further comprises removing the compacted alumina green body from the casting mold and subjecting the compacted alumina green body to a sintering thereby providing a single unitary compacted alumina piece. In some embodiments, the sintering comprises heating at a temperature of about 1200° C. to about 1800° C. In some embodiments, the sintering comprises heating at a temperature of about 1400° C. to about 1800° C. In some embodiments, the sintering comprises heating at a temperature of about 1600° C. to about 1800° C. In some embodiments, the sintering is conducted for about 0.5 hour to about 24 hours. In some embodiments, the sintering is conducted for about 2 hours to about 12 hours. In some embodiments, the sintering is conducted for about 2 hours to about 8 hours.

In some embodiments, the casting mold is made of foamed plastic, Styrofoam™, polytetrafluoroethylene (PTFE), silicon polymer, polystyrene. In some embodiments, the casting mold is of rectangular shape, square shape, circular, or oval. In some embodiments, the casting mold has a thickness of about 50 mm to about 200 mm. In some embodiments, the casting mold has a thickness of about 100 mm to about 200 mm. In some embodiments, the casting mold has a thickness of about 100 mm to about 150 mm.

In some embodiments, the compacted alumina green body has a bulk density of about 2.0 g/cm³ to about 3.3 g/cm³. In some embodiments, the compacted alumina green body has a bulk density of about 2.3 g/cm³ to about 3.0 g/cm³. In some embodiments, the compacted alumina green body has a bulk density of about 2.5 g/cm³ to about 2.8 g/cm³.

In some embodiments, the single unitary compacted alumina piece has a bulk density of about 3.0 g/cm³ to about 3.7 g/cm³. In some embodiments, the single unitary compacted alumina piece has a bulk density of about 3.1 g/cm³ to about 3.6 g/cm³. In some embodiments, the single unitary compacted alumina piece has a bulk density of about 3.2 g/cm³ to about 3.5 g/cm³.

In some embodiments, the process is free of a mechanical compaction step.

Also provided is a compacted alumina green body produced by the process of the present application.

The present application further includes a compacted alumina green body comprising compacted micron-sized particles of high-purity alumina.

Also provided is a single unitary compacted alumina piece produced by the process of the present application.

The present application further includes a single unitary compacted alumina piece comprising compacted micron-sized particles of high-purity alumina.

In some embodiments, the compacted alumina green body and single unitary compacted alumina piece have the properties has defined above.

Also included is a use of an alumina green body or a single unitary compacted alumina piece of the present application, in single crystal growth process.

Also provided is a use of an alumina green body or a single unitary compacted alumina piece of the present application, in a single crystal growth furnace.

Further included is a use of an alumina green body or a single unitary compacted alumina piece of the present application, in the production of sapphire.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### BRIEF DESCRIPTION OF DRAWINGS

The embodiments of the application will now be described in greater detail with reference to the attached drawings in which:

FIG. 1 shows a flowchart diagram of a representative process of the prior art.

FIG. 2 shows a flowchart diagram of the process of the application, according to exemplary embodiments.

FIG. 3 shows an image of an exemplary compacted alumina green body (Example 1) obtained from the process of the application, according to exemplary embodiments.

FIG. 4 shows an image of an exemplary compacted alumina monolith (Example 1) obtained from the process of the application, according to exemplary embodiments.

FIG. 5 an image of an exemplary compacted alumina green body (Example 2) obtained from the process of the application, according to exemplary embodiments.

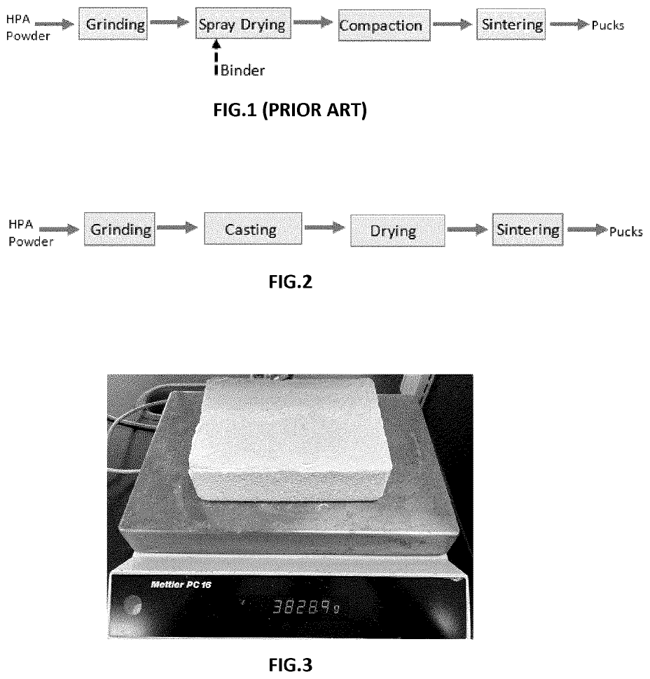

### DETAILED DESCRIPTION

### I. Definitions

Unless otherwise indicated, the definitions and embodiments described in this and other sections are intended to be applicable to all embodiments and aspects of the present application herein described for which they are suitable as would be understood by a person skilled in the art.

As used in this application and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “consisting” and its derivatives as used herein are intended to be closed terms that specify the presence of the stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

As used in the present application, the singular forms “a”, “an” and “the” include plural references unless the content clearly dictates otherwise.

In embodiments comprising an “additional” or “second” component, the second component as used herein is chemically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

The term “suitable” as used herein means that the selection of the particular composition or conditions would depend on the specific steps to be performed, the identity of the components to be transformed and/or the specific use for the compositions, but the selection would be well within the skill of a person trained in the art.

The terms “smelter grade alumina” or “SGA” as used herein refer to a grade of alumina that may be useful for processes for preparing aluminum metal. Smelter grade alumina typically comprises α-Al₂O₃ in an amount of less than about 5 wt %, based on the total weight of the smelter grade alumina.

The terms “high purity alumina” or “HPA” as used herein refer to a grade of alumina that comprises alumina in an amount of 99 wt % or greater, based on the total weight of the high purity alumina.

The expression “transition alumina” as used herein refers to a polymorphic form of alumina other than α-alumina. For example, the transition alumina can be χ-Al₂O₃, κ-Al₂O₃, γ-Al₂O₃, θ-Al₂O₃, δ-Al₂O₃, η-Al₂O₃, ρ-Al₂O₃ or combinations thereof.

The expression “amorphous alumina” as used herein refers to a non-crystalline polymorph of alumina that lacks the long-range order characteristic of a crystal.

The term “sintering” as used herein generally refers to a thermal process of converting loose fine particles into a solid coherent mass by heat, and optionally pressure, without fully melting the particles to the point of melting.

The term “single crystal growth” as used herein generally refers to growth of bulk inorganic single crystals, which are solids in which the crystal lattice of the entire sample is continuous and unbroken to the edges of the sample, with no grain boundaries.

The term “green body” as used herein in the context of alumina refers to a bulk of material that usually needs to be further processed before being used, for example by firing, sintering, or the like.

The term “monolith” as used herein, in the context of alumina, refers to a single, massive, organized block and is also interchangeably referred to as a single unitary compacted alumina piece.

The terms “kiln”, “furnace” and “oven” as used herein are being used interchangeably and refer to a thermally insulated chamber that produces temperatures sufficient to complete a process converting a material into another form or a chemically different material, for example through hardening, drying, calcinating, etc.

### II. Methods and Uses of the Application

It has been surprisingly shown herein that compacted alumina monolith may be produced according to process of the application, providing larger monoliths having higher density suitable for use in single crystal growth industry such as synthetic sapphire. As such, the process of the present application provides for the production of compacted monolith with reduced level of impurities, while also reducing operations challenges and costs. The present application further provides for the use of these process for the production of compacted alumina monolith, and monoliths obtained therefrom. Comparable processes did not display the same properties, highlighting the surprising results obtained with the process of the application.

Accordingly, the present application includes a process for production of a compacted alumina green body, comprising: pouring a slurry in a casting mold, the slurry comprising micron-sized particles of high-purity alumina and a solvent; and drying the slurry to obtain the compacted alumina green body.

In some embodiments, the high-purity alumina (HPA) is selected from alpha alumina, transition alumina, amorphous alumina, and a mixture thereof. In some embodiments, the HPA is doped with at least one element, or is a mixture of HPA and other metal oxides. In some embodiments, the dopant is selected from Mg, Ba, Si, Ti, Zr, Fe, W, Zn, and rare earth elements. A skilled person would appreciate that variations in the composition of the starting material may be made according to the different intended uses of the final compacted material.

In some embodiments, the solvent is selected from water, methanol, ethanol, isopropanol, acetone and mixtures thereof. In some embodiments, the solvent is water.

In some embodiments, the process further comprises grinding the high-purity alumina to obtain the micron-sized particles. In some embodiments, wherein the grinding is conducted in a wet grinder, a dry grinder, a ball mill, an air jet mill, a steam jet mill, or the like. It would be within the purview of a skilled person in the art to select appropriate techniques and equipment to grind a material to an appropriate size.

In some embodiments, the micron-sized high-purity alumina particles have a particle size distribution from about 0.5 micron to about 100 microns. In some embodiments, the micron-sized high-purity alumina particles have a particle size distribution from about 0.5 micron to about 50 microns. In some embodiments, wherein the micron-sized high-purity alumina particles have a particle size distribution from about 1 micron to about 5 microns.

In some embodiments, the solvent is in an amount of about 5% to about 75% by weight based on the total weight slurry. In some embodiments, the solvent is in an amount of about 10% to about 40% by weight based on the total weight slurry. In some embodiments, the solvent is in an amount of about 10% to about 20% by weight based on the total weight slurry.

In some embodiments, the slurry is obtained by mixing the high-purity alumina and the solvent.

In some embodiments, the slurry further comprises an organic binder, a dispersant, or a mixture thereof. In some embodiments, the organic binder is a polymer selected from carboxymethyl-cellulose (CMC), poly-vinyl-alcohols (PVA) and poly-ethylene glycols (PEG). In some embodiments, the dispersant is selected from 4,5-dihydroxy-1,3-benzenedisulfonic acid disodium salt (Tiron™), carbonic acid salt (Dolapix™ CE 64), Ammonium polymethacrylate (Darvan™ C), Carbonic acid ester (Dolapix ET 85), sodium pyrophosphate, diammonium hydrogen citrate, Triammonium salt of aurintricarboxylic acid (Aluminon™), Darvan C—N, sodium pyrophosphate, diammonium hydrogen citrate, citric acid, nitric acid, ascorbic acid, ammonium polyacrylate (Seruna™ D-305), and polycarbonic acid salt (Dolapix PC33). In some embodiments, the process is free of a binder.

In some embodiments, the process further comprises a settlement period before drying the slurry to allow settlement of the micron-sized particles. In some embodiments, the settlement period further comprises vibrating the casting mold. In some embodiments, the settlement period is conducted for about 0.5 hour to about 24 hours. In some embodiments, the settlement period is conducted for about 1 hour to about 12 hours. In some embodiments, the settlement period is conducted for about 1 hour to about 5 hours.

In some embodiments, the drying is conducted in an oven, a gas fired dryer, an electrical dryer or a microwave oven. In some embodiments, the drying is conducted at a temperature of about 15° C., to about 150° C. In some embodiments, the drying comprises heating at a temperature of about 30° C. to about 150° C. In some embodiments, the drying comprises heating at a temperature of about 50° C. to about 150° C. In some embodiments, the drying is conducted for about 0.5 hour to about 1 week. In some embodiments, the drying is conducted for about 1 hour to about 48 hours. In some embodiments, the drying is conducted for about 12 hours to about 24 hours.

In some embodiments, the process further comprises removing the compacted alumina green body from the casting mold and subjecting the compacted alumina green body to a thermal treatment thereby providing a single unitary compacted alumina piece. In some embodiments, wherein the thermal treatment comprises heating at a temperature of about 150° C. to about 1200° C. In some embodiments, the thermal treatment comprises heating at a temperature of about 200° C. to about 1200° C. In some embodiments, the thermal treatment comprises heating at a temperature of about 250° C. to about 1200° C. In some embodiments, the thermal treatment is conducted for about 0.5 hour to about 24 hours. In some embodiments, the thermal treatment is conducted for about 1 hour to about 12 hours. In some embodiments, the thermal treatment is conducted for about 2 hours to about 5 hours.

In some embodiments, the process further comprises removing the compacted alumina green body from the casting mold and subjecting the compacted alumina green body to a sintering thereby providing a single unitary compacted alumina piece. In some embodiments, the sintering comprises heating at a temperature of about 1200° C. to about 1800° C. In some embodiments, the sintering comprises heating at a temperature of about 1400° C. to about 1800° C. In some embodiments, the sintering comprises heating at a temperature of about 1600° C. to about 1800° C. In some embodiments, the sintering is conducted for about 0.5 hour to about 24 hours. In some embodiments, the sintering is conducted for about 2 hours to about 12 hours. In some embodiments, the sintering is conducted for about 2 hours to about 8 hours.

In some embodiments, the casting mold is made of foamed plastic, Styrofoam™, polytetrafluoroethylene (PTFE-Teflon™), silicon polymer, polystyrene. In some embodiments, the casting mold is of rectangular shape, square shape, circular, oval, or the like. In some embodiments, the casting mold has a thickness of about 50 mm to about 200 mm. In some embodiments, the casting mold has a thickness of about 100 mm to about 200 mm. In some embodiments, the casting mold has a thickness of about 100 mm to about 150 mm. A skilled person in the art would readily appreciate that the size and shape of the mold may be readily tunable according to the desired end product and its use.

In some embodiments, the compacted alumina green body has a bulk density of about 2.0 g/cm³ to about 3.3 g/cm³. In some embodiments, the compacted alumina green body has a bulk density of about 2.3 g/cm³ to about 3.0 g/cm³. In some embodiments, the compacted alumina green body has a bulk density of about 2.5 g/cm³ to about 2.8 g/cm³.

In some embodiments, the compacted alumina monolith (single unitary piece), i.e. after thermal treatment/sintering, has a bulk density of about 3.0 g/cm³ to about 3.7 g/cm³. In some embodiments, the compacted alumina green body has a bulk density of about 3.1 g/cm³ to about 3.6 g/cm³. In some embodiments, the compacted alumina green body has a bulk density of about 3.2 g/cm³ to about 3.5 g/cm³.

In some embodiments, the process is free of a mechanical compaction step.

The present application further provides a compacted alumina green body and a single unitary compacted alumina piece produced by the process of the application.

An alumina green body or a single unitary compacted alumina piece comprising compacted micron-sized particles of high-purity alumina is also included.

In some embodiments, the compacted alumina green body and a single unitary compacted alumina piece will have the shape and dimensions of the casting mold, as defined above. Again, a person of skill in the art would readily appreciate that the size and shape of the mold are readily tunable to provide the compacted alumina green body and single unitary compacted alumina piece of desired size and shape according to the desired uses.

The present application further provides use of a compacted alumina green body and a single unitary compacted alumina piece, for use in single crystal growth.

The present application further provides use of a compacted alumina green body and a single unitary compacted alumina piece, in a single crystal growth furnace.

In some embodiments, the process of the present application can be used to produce compacted material as feed for synthetic sapphire industry. Main applications of sapphire are for example, but not limited to, wafer for semiconductors and camera lens, jewelry, medical, defense, aerospace, watches, display covers and LEDs.

### EXAMPLES

The following non-limiting examples are illustrative of the present application.

### General Methods

A flowchart of the process of the present application is shown in FIG. 2. The feed material (HPA powder) was ground to produce micron-sized powder in a wet grinder. The output of the grinder was a slurry of alumina. Optionally, the feed material may already be micron sized, and the grinding step can be eliminated. In such a case, demineralized water can be added in an amount of 10 to 30 wt % to the alumina powder to produce the slurry. The slurry was then casted/poured into molds. Before drying, the casted material was placed for a few hours undisturbed in order to allow time for alumina particles to settle down (settlement period). Without being bound to theory, during this step the alumina particles settled in an organized manner to minimize the gap between the particles and maximize the green body density. When the settlement of the material was done, the excess water can be optionally removed from the surface of the sedimented part. Then, the mold was placed in an oven to remove the additional free water and dry the slurry. The oven temperature can vary between room temperature to 150° C. When the free water was evaporated, the green body material was removed from mold and the green body density was between 2.0-2.8 g/cm³. For some applications of single crystal growing operations, the green body may be used as is. Optionally, further thermal treatment may be conducted, such as sintering.

### Example 1

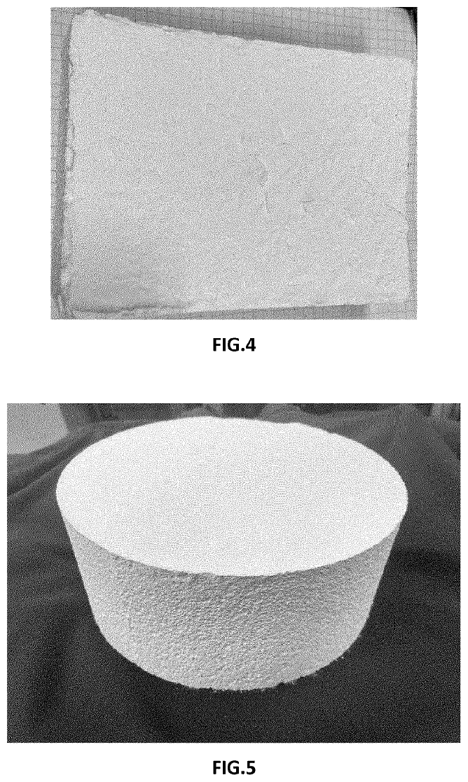

4.00 kg of micron sized high purity alumina (99.999%), sourced from decomposition of aluminum chloride hexahydrate, was mixed with demineralized water to produce a slurry of alumina. The concentration of water in the slurry was 20% wt. The slurry was poured into a rectangular Styrofoam™ mold having a dimension of 195 mm×145 mm. The material was left in the lab environment overnight (settlement period). Then it was dried in an oven at about 80° C. The material was removed from mold and its green body density was >2.6 g/cm³, as shown in FIG. 3. The block was then sintered at a high temperature of 1600° C. for 5 hours. The obtained sintered monolith is shown in FIG. 4 and its density was 3.3 g/cm³.

### Example 2

Micron sized alpha high purity alumina (99.999%), sourced from decomposition of aluminum chloride hexahydrate, was mixed with demineralized water to produce a slurry of alumina. The concentration of water in the slurry was 15% wt. The slurry was poured into a cylindrical Styrofoam mold having a diameter of 241.3 mm. The material was left in the lab environment overnight (settlement period). Then it was dried in an oven for 48 hours at 70-80° C. The material was removed from the mold and the green body is shown in FIG. 5 with a density of 2.639 g/cm³, height: 97 mm, weight: 11.2 kg, and diameter: 237 mm. The green body was then sintered for about 5 hours at about 1600° C. to give a monolith having a density of 3.2 g/cm³, height: 86.9 mm, and diameter: 212-218 mm.

### Results

As shown in the above examples, the process of the application produces monolith compacted material that can fit inside the crucible of single crystal growth furnace. Compared to common methods of producing small rectangular compacted material, the gap between compacted material is reduced, and therefore more material can be loaded into the furnace. This process of the application provides for simple, reliable, flexible, cost-effective and contaminant-free process.

The compacted material can be produced in any shape and any size depending on the shape and dimensions of the single crystal growth furnace, while the common method is only able producing small rectangular shapes.

The process of the application also removes the uniaxial compaction step, reducing the capital and operation costs, and avoiding the cross contamination from the die and the punch of the press machine.

The process of the application also replaces the complicated spray drying step with a conventional drying, also reducing capital and operation costs.

As the addition of an organic binder is optional in the process of the application also, potential contamination from the binder can be avoided. Let alone the advantage of avoiding purchasing cost of high purity binder.

Finally, the density of the obtained green body is very high (2.7-2.8 g/cm³), which may be directly used in single crystal growth furnace, thus avoiding the need of a costly and high maintenance sintering furnace.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A process for production of a compacted alumina green body, comprising:
pouring a slurry in a casting mold, the slurry consisting of micron-sized particles of high-purity alumina that is optionally doped, the high-purity alumina having a particle size distribution of about 1 micron to about 5 microns and a solvent, the solvent being in an amount of about 5% to about 25% by weight based on the total weight slurry; and
drying the slurry to obtain the compacted alumina green body having a bulk density of about 2.5 g/cm³ to about 2.8 g/cm³.

2. The process of claim 1, wherein the high-purity alumina is selected from alpha alumina, transition alumina and amorphous alumina or the high-purity alumina is doped with at least one element selected from Mg, Ba, Si, Ti, Zr, Fe, W, Zn and rare earth elements, or is a mixture of high-purity alumina and metal oxides.

3. The process of claim 1, further comprising grinding the high-purity alumina to obtain the micron-sized particles.

4. (canceled)

5. The process of claim 1, wherein the solvent is in an amount of about 10% to about 20% by weight based on the total weight slurry.

6. (canceled)

7. The process of claim 1, wherein the solvent is selected from water, methanol, ethanol, isopropanol, acetone and mixtures thereof.

8. The process of claim 1, wherein the solvent is water.

9. The process of claim 1, further comprising a settlement period before drying the slurry to allow settlement of the micron-sized particles.

10. The process of claim 9, wherein the settlement period further comprises vibrating the casting mold.

11. (canceled)

12. The process of claim 9, wherein the settlement period is conducted for about 1 hour to about 12 hours.

13. (canceled)

14. The process of claim 1, wherein the drying is conducted in an oven, a gas fired dryer, an electrical dryer or a microwave oven.

15. (canceled)

16. The process of claim 1, wherein the drying comprises heating at a temperature of about 30° C. to about 150° C.

17-18. (canceled)

19. The process of claim 1, wherein the drying is conducted for about 1 hour to about 48 hours.

20. (canceled)

21. The process of claim 1, further comprising removing the compacted alumina green body from the casting mold and subjecting the compacted alumina green body to a thermal treatment thereby providing a single unitary compacted alumina piece.

22-23. (canceled)

24. The process of claim 21, wherein the thermal treatment comprises heating at a temperature of about 250° C. to about 1200° C.

25. (canceled)

26. The process of claim 21, wherein the thermal treatment is conducted for about 1 hour to about 12 hours.

27. (canceled)

28. The process of claim 1, further comprising removing the compacted alumina green body from the casting mold and subjecting the compacted alumina green body to a sintering thereby providing a single unitary compacted alumina piece.

29. (canceled)

30. The process of claim 28, wherein the sintering comprises heating at a temperature of about 1400° C. to about 1800° C.

31-32. (canceled)

33. The process of claim 28, wherein the sintering is conducted for about 2 hours to about 12 hours.

34. (canceled)

35. The process of claim 1, wherein the casting mold is made of foamed plastic, Styrofoam™, polytetrafluoroethylene (PTFE), silicon polymer, polystyrene.

36-37. (canceled)

38. The process of claim 1, wherein the casting mold has a thickness of about 100 mm to about 200 mm.

39. (canceled)

40. The process of claim 21, wherein the single unitary compacted alumina piece has a bulk density of about 3.1 g/cm³ to about 3.6 g/cm³.

41. The process of claim 21, wherein the single unitary compacted alumina piece has a bulk density of about 3.2 g/cm³ to about 3.5 g/cm³.

42. The process of claim 1, which is free of a mechanical compaction step.

43. The process of claim 1, which is free of binder.

44-78. (canceled)
